(19) United States
(12) Patent Application Publication
(10) Pub. No.: US 2026/0120497 A1
(43) Pub. Date: Apr. 30, 2026

(54) MODIFICATION PROPOSAL METHOD, MODIFICATION PROPOSAL SYSTEM, AND NON-TRANSITORY COMPUTER-READABLE MEDIUM

(71) Applicant: LEGALON TECHNOLOGIES, INC., Tokyo (JP)

(72) Inventors: Taizo YAMADA, Tokyo (JP); Akihiko MATSUBA, Tokyo (JP); Aya OHATA, Tokyo (JP); Takashi KAWATO, Tokyo (JP)

(73) Assignee: LEGALON TECHNOLOGIES, INC., Tokyo (JP)

(21) Appl. No.: 19/397,353

(22) Filed: Nov. 21, 2025

Related U.S. Application Data
(63) Continuation of application No. PCT/JP2024/018963, filed on May 23, 2024.

(30) Foreign Application Priority Data
May 23, 2023 (JP) 2023-084575

(51) Int. Cl. G06V 30/413; G06F 40/194; G06F 40/197

(52) U.S. Cl. CPC G06V 30/413; G06F 40/194; G06F 40/197

(57) ABSTRACT

Provided is a document processing method to be performed by a processor, the document processing method including: acquiring target document information as a target to be reviewed by a user and first comparison document information for comparison to the target document information; and extracting at least one piece of second comparison document information from a plurality of pieces of document information stored in a predetermined storage unit, based on the first comparison document information.

### CROSS-REFERENCE TO RELATED APPLICATION

This application is a continuation of International Application No. PCT/JP2024/018963, filed on May 23, 2024. This application also claims the benefit of priority under 35 U.S.C. § 119(a) to Japanese Patent Application No. 2023-084575, filed on May 23, 2023. The entire contents of both of the above applications are incorporated herein by reference.

### BACKGROUND

The present disclosure relates to a document processing method, a document processing system, and a document processing program.

### Related Art

There is a conventionally known system that assists a user in processing electronic documents different in version.

For example, a document management system described in JP 2003-167911 A(Patent Literature 1) classifies a plurality of documents including files into folders for management and stores, in a case where each document is updated, the corresponding document before update as an old version into a document management database. The system includes a searching unit having a function of searching for a latest version in a specified folder and an old version of each document as a searching target and a control unit that controls the searching unit.

### SUMMARY

According to an embodiment of the present disclosure, provided is a document processing method to be performed by a processor, the document processing method including: acquiring target document information as a target to be reviewed by a user and first comparison document information for comparison to the target document information; and extracting at least one piece of second comparison document information from a plurality of pieces of document information stored in a predetermined storage unit, based on the first comparison document information.

### BRIEF DESCRIPTION OF DRAWINGS

FIG. 1 illustrates an outline of processing in a document processing system according to an embodiment of the present disclosure;

FIG. 2 illustrates the configuration of the document processing system according to the embodiment of the present disclosure;

FIG. 3 illustrates an example of a screen that is displayed on a user terminal and displays target document information;

FIG. 4 illustrates an example of pre-switching display information displayed on the user terminal;

FIG. 5 illustrates an example of candidate display information displayed on the user terminal;

FIG. 6 illustrates an example of post-switching display information displayed on the user terminal;

FIG. 7 is a flowchart illustrating an example of processing in the document processing system; and

FIG. 8 illustrates an example of a hardware configuration of a computer.

### DETAILED DESCRIPTION

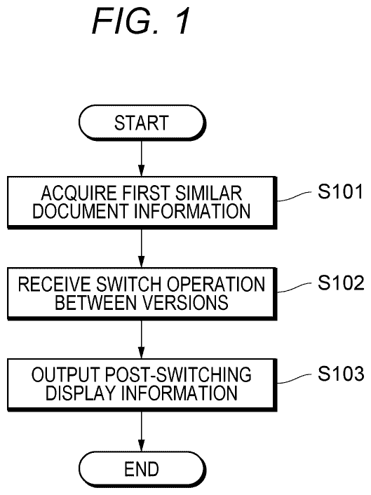

Embodiments of the present disclosure will be described with reference to the accompanying drawings. FIG. 1 illustrates an outline of processing in a document processing system 100 according to an embodiment of the present disclosure.

In order to inspect or amend an electronic document (e.g., a contract), the descriptions in the electronic document may be compared with reference to the descriptions in an electronic document in a different version. However, the document management system described in Patent Literature 1 A merely searches for the corresponding electronic document from a plurality of electronic documents including electronic documents in old versions and thus does not take account of comparison of descriptions with reference to the descriptions of a document in a different version.

Thus, an object of an embodiment of the present disclosure is to provide a document processing method, a document processing system, and a document processing program that enable easy switching between electronic documents for comparison.

According to an embodiment of the present disclosure, a switch can be made easily between electronic documents for comparison.

The document processing system 100 may serve as an information processing system that is achieved by a document processing program and acquires first comparison document information for comparison to target document information as a target to be reviewed, and extracts and displays, in response to an operation from a user, second comparison document information (namely, for example, electronic document information different from the first comparison document information).

In other words, the document processing system 100 may switch the comparison target from the first comparison document information to the second comparison document information.

Here, the document processing system 100 can use, as the first comparison document information, for example, first similar document information similar to the target document information. In addition, the document processing system 100 can use, as the second comparison document information, for example, second comparison document information belonging to a series of amendment steps identical to that of the first comparison document information, particularly, for example, second similar document information belonging to a series of amendment steps identical to that of the first similar document information. Hereinafter, unless otherwise particularly specified, an embodiment in which the first comparison document information is the first similar document information and the second comparison document information is the second similar document information will be given, but the first comparison document information and the second comparison document information are not limited to the embodiment. That is, the first similar document information and the second similar document information may be as appropriate regarded as the first comparison document information and the second comparison document information, respectively.

In order to review target document information, a user may refer to an amendment process in electronic document information similar to the target document information (first similar document information to be described later) and electronic document information resulting from amendment based on the amendment process (second similar document information to be described later). Thus, the user can review the target document information with reference to the amendment in a past document (e.g., a past similar document). The document processing system 100 may serve as an information processing system that performs document processing regarding reference to the second similar document information by the user.

First, the document processing system 100 may acquire target document information, for example, in response to an operation from a user. The document processing system 100 may acquire first similar document information similar to the target document information, based on the target document information (S101).

Next, the document processing system 100 may extract at least one piece of second similar document information belonging to a series of amendment steps identical to that of the first similar document information and then receives a switch operation from the user (S102). In response to the switch operation, the document processing system 100 may output post-switching display information for displaying the second similar document information (S103).

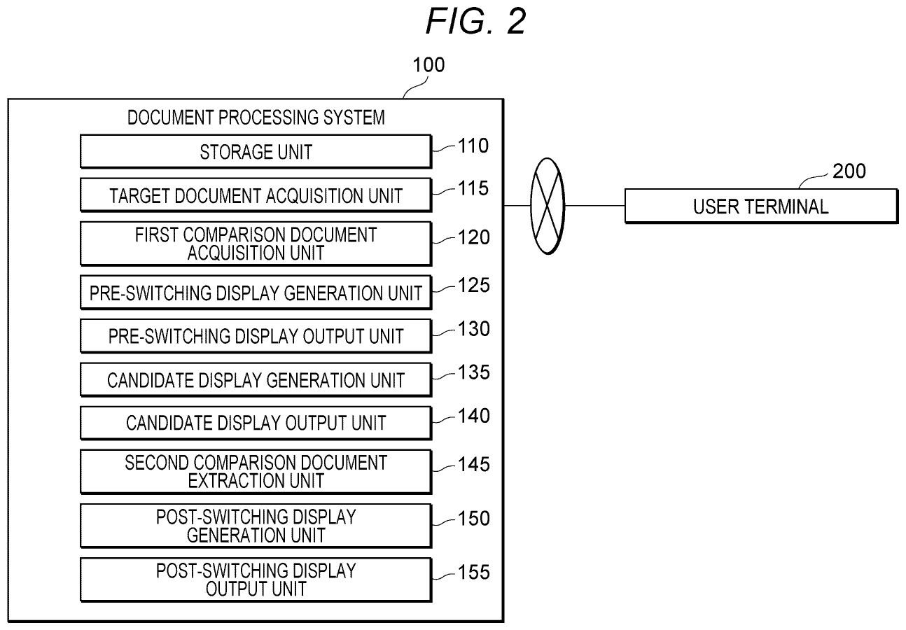

FIG. 2 illustrates the configuration of the document processing system 100 according to the embodiment of the present disclosure. The document processing system 100 may be communicably connected to a user terminal 200 through a network, such as the Internet. Details of the document processing system 100 will be described later.

The user terminal 200 in the present embodiment may correspond to a computer that a user uses, such as a smartphone, a tablet terminal, or a personal computer.

The user terminal 200 may acquire display information output from the document processing system 100 (pre-switching display information, candidate display information, or post-switching display information, which will be described later) and then display the corresponding screen.

Note that only one user terminal 200 is illustrated in FIG. 2, but a plurality of user terminals 200 may be provided. A single user may use a plurality of user terminals 200 or a single user terminal 200 may be used between a plurality of users.

Next, details of the document processing system 100 will be described. The document processing system 100 may include a storage unit 110, a target document acquisition unit 115, a first comparison document acquisition unit 120, a pre-switching display generation unit 125, a pre-switching display output unit 130, a candidate display generation unit 135, a candidate display output unit 140, a second comparison document extraction unit 145, a post-switching display generation unit 150, and a post-switching display output unit 155. For example, use of a storage area may enable achievement of each unit illustrated in FIG. 2 or a processor may execute a program stored in the storage area to achieve each unit.

The storage unit 110 in the present embodiment may store information to be processed in the document processing system 100. The storage unit 110 can store, for example, target document information, first comparison document information, second comparison document information, pre-switching display information, candidate display information, and post-switching display information, which will be described later.

The target document acquisition unit 115 in the present embodiment may acquire target document information as a target to be reviewed by a user and stores the target document information into the storage unit 110.

Here, such a review may be, for example, an inspection of electronic document information by the user. The target document information may be, for example, electronic document information as a target to be reviewed by the user.

Such electronic document information may be amended as necessary for completion. For example, in a case where the electronic document information is electronic document information on a business report, the person in charge of business may write a draft and then the business manager (e.g., a person superior in rank to the person in charge of business) may amend the draft to finalize the business report.

For example, in a case where the electronic document information is electronic document information on a contract, for agreement between contracting parties, one or both of the contracting parties may inspect and amend the contract. As an example, for contract between companies, for example, the legal department in charge of contract inspection may inspect the content of the contract and amend the content as necessary. Note that such inspection may be also referred to as confirmation or examination.

The target document information in the present embodiment may be, for example, electronic document information on a contract. The target document information may be, for example, electronic document information on a contract created by a predetermined electronic document creation software product, electronic document information resulting from digitization of a contract on a paper medium using a predetermined image analysis technology (e.g., an optical character recognition (OCR) technology), or electronic document information generated by the document processing system 100, an external system, or using a template or a document creation function (e.g., an editor function) provided by a service. Examples of a contract as a target to be processed by the document processing system 100 may include a document that includes clauses and causes a predetermined legal effect, an application form, and a memorandum.

Examples of such a contract may include a contract agreed to and concluded by both parties, a contract being confirmed by both parties (namely, a contract proposal), a contract that has been exchanged between the parties but has not reached an agreement, and a contract template created for reference in contract with another party. In the description of the present embodiment, unless otherwise particularly noted, the term “contract” may mean a contract agreed to by both parties, a contract being confirmed by both parties (namely, a contract proposal), a contract that has been exchanged between the parties but has not reached an agreement, or a contract template created for reference in contract with another party. In the present embodiment, the target document information may correspond to a confirmed contract, a latest version of contract, or a contract not in the latest version.

Electronic document information (e.g., first comparison document information or second comparison document information, which will be described later, or the target document information) may include, for example, text, figure, or table data indicating the content of the electronic document information.

The electronic document information may further include title information indicating the title of the electronic document, status information indicating the status of the electronic document (e.g., reviewed, agreed, other-party amendment proposal, other-party draft, primary proposal, or template), order information indicating the order of amendments, type information indicating the type of the contract, and position information indicating the position of the contract. The electronic document information may be information on a document basis or information on a predetermined item-by-item basis (e.g., article, paragraph, or item). The electronic document information (particularly, first comparison document information and second comparison document information, which will be described later) may be required at least to be stored in a predetermined storage unit, and may be stored, for example, in the storage unit 110, a storage unit in a device that the user uses (e.g., in the user terminal 200 or a server device of the business operator to which the user belongs), or a storage unit in a device managed by a business operator that provides a predetermined data storage service. In a case where the electronic document information corresponds to a concluded contract, the electronic document information may be captured from an electronic contract system to the document processing system 100 or may be stored in a storage unit in the electronic contract system.

Here, the type in the present embodiment may be information indicating the type of the content of a contract, such as “non-disclosure agreement” or “outsourcing agreement”. The position in the present embodiment may be information indicating contractual position, such as “disclosing party” or “outsourcing party”. Note that the title information, the status information, the order information, the type information, and the position information may be information set in accordance with an input from the user or information extracted based on analysis of the electronic document information by an information processing system (e.g., the document processing system 100). In the present embodiment, preferably, each piece of electronic document information may include the order information.

The language of the electronic document information may be, for example, Japanese, English, or any other language.

The target document acquisition unit 115 can acquire target document information, for example, from the user terminal 200. In this case, for example, the document processing system 100 may receive target document information uploaded from the user through the user terminal 200 to acquire the target document information.

Note that the target document acquisition unit 115 may acquire, for example, target document information stored in an external information processing system. In this case, the target document acquisition unit 115 may acquire the target document information, for example, in response to an operation from the user.

The first comparison document acquisition unit 120 in the present embodiment acquires first comparison document information and then stores the first comparison document information into the storage unit 110. The first comparison document acquisition unit 120 may acquire first similar document information similar to the target document information.

The first similar document information in the present embodiment may correspond to electronic document information similar to the target document information. The document processing system 100 can acquire, as the first similar document information, for example, electronic document information that fulfills a predetermined degree of matching with the target document information. The predetermined degree of matching may be based on, for example, the degree of matching with the text included in the electronic document information, the degree of matching with the title information, status information, type information, or position information included in the electronic document information, or may be the degree of matching based on a different technique.

In a case where the first similar document information and second similar document information to be described later correspond to, for example, a document or contract similar in type, party, or template to that of the target document information or a document or contract that has been reviewed and is suitable as a sample for the user, the embodiment of the present embodiment may be favorable.

For example, the first comparison document acquisition unit 120 may extract first similar document information from the electronic document information stored in a predetermined storage unit (particularly, for example, in the storage unit 110 or a storage unit in an external information processing system) to acquire the first similar document information.

In this case, for example, based on a predetermined degree of matching with the target document information, the first comparison document acquisition unit 120 may extract the first similar document information from the electronic document information stored in the predetermined storage unit. The first similar document information may be extracted due to searching or recommendation based on a large language model (LLM).

In a case where the target document information is electronic document information that has not yet been reviewed or is being reviewed by the user, the first comparison document acquisition unit 120 may extract and acquire, as the first similar document information, electronic document information that has not yet been reviewed by the user. Thus, with reference to an amendment process in similar electronic document information, the user can grasp the content to be amended in the target document information. In this case, for example, based on the order information included in the target document information, the first comparison document acquisition unit 120 may acquire, as the first similar document information, electronic document information belonging to a series of amendment steps identical to that of the target document information.

For example, the first comparison document acquisition unit 120 may extract and acquire, as the first similar document information, electronic document information of which the status information indicates “agreed” or “reviewed”. Thus, for example, with reference to electronic document information indicating that agreement with the other party has been completed or that review has been completed in our own company from similar electronic document information, the user can grasp the content to be amended in the target document information.

The first comparison document acquisition unit 120 may extract a plurality of pieces of electronic document information as candidates for the first similar document information and may further acquire the first similar document information from the candidates in response to a selection operation from the user. Thus, for reviewing the target document information, the first similar document information to be referred to can be properly selected.

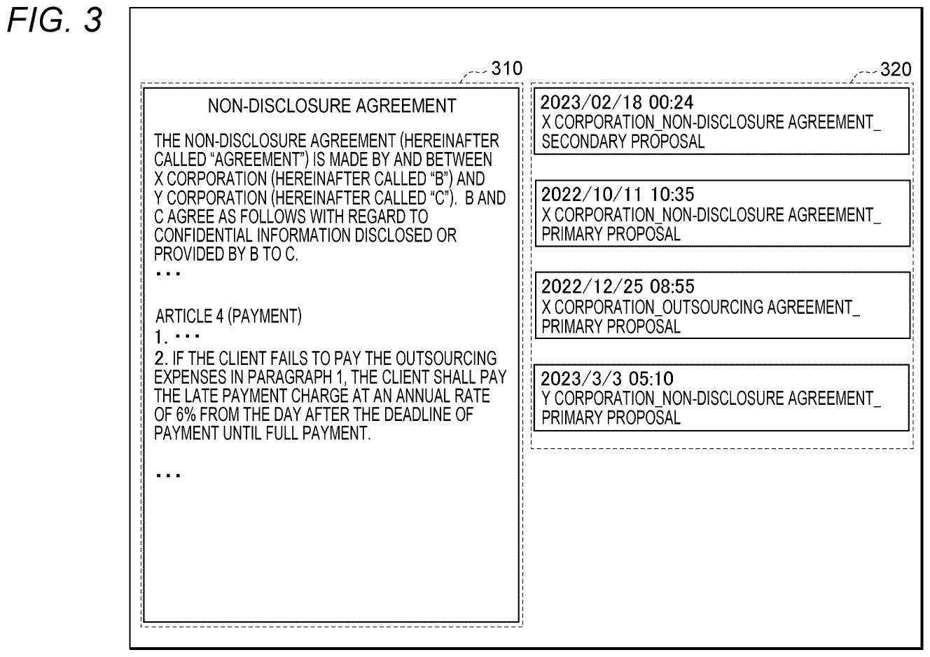

In this case, in response to a selection operation to the candidates for the first similar document information displayed on a screen that displays the target document information, the first comparison document acquisition unit 120 may acquire the first similar document information. A specific description will be given with FIG. 3. FIG. 3 illustrates an example of a screen that is displayed on the user terminal 200 and displays the target document information (namely, a preview screen).

The screen illustrated in FIG. 3 may include, for example, a region 310 for displaying the target document information and a region 320 that displays information regarding a plurality of pieces of electronic document information as candidates for the first similar document information. The information regarding a plurality of pieces of electronic document information as candidates for the first similar document information may include, for example, the respective pieces of title information on the plurality of pieces of electronic document information, at least part of the respective contents of the plurality of pieces of electronic document information, or at least part of the type information on the plurality of pieces of electronic document information.

With reference to the content of the target document information on the screen illustrated in FIG. 3, the user can select proper first similar document information. Then, the first comparison document acquisition unit 120 can extract, as the first similar document information, the electronic document information selected by the user.

Note that, due to an operation from the user, a switch may be made between display and non-display for the region 320.

The region 320 may further display information indicating the parties regarding the plurality of pieces of electronic document information displayed (e.g., a counterparty). The region 320 may further display a screen for receiving an input regarding a party from the user for narrowing to the party. That is, in response to an input from the user, the region 320 may display a plurality of pieces of electronic document information corresponding to the input. Thus, the user can receive a display of only the electronic document information related to the party that the user desires from the plurality of pieces of electronic document information, and thus can easily extract, for example, a continuous contract with a particular party.

The pre-switching display generation unit 125 in the present embodiment may generate pre-switching display information for displaying the target document information and the first similar document information with pre-switching difference indicating the difference between the target document information and the first similar document information, displayed in a highlighting manner and then store the pre-switching display information into the storage unit 110.

The pre-switching difference in the present embodiment may be, for example, the difference between the text included in the target document information and the text included in the first similar document information or the difference between the table included in the target document information (particularly, for example, the structure of the table and the text included in the table) and the table included in the first similar document information (particularly, for example, the structure of the table and the text included in the table).

The “highlighting” in the present embodiment may include displaying the difference (pre-switching difference or post-switching difference to be described later) in a mode different from that of the other part. More specifically, the “highlighting” may include, but is not limited to, displaying any character in the difference differently from any character in the other part in terms of decoration, thickness, font, or color, displaying a rectangle in a predetermined color that is superposed on the content, like a highlight, changing the color of the background in the range of a provision, a cell, or the like, and displaying any character in the other part unnoticeably, such as with low contrast between any character in the other part and the background.

The pre-switching display output unit 130 in the present embodiment may output pre-switching display information. The pre-switching display output unit 130 can output the pre-switching display information, for example, to the user terminal 200.

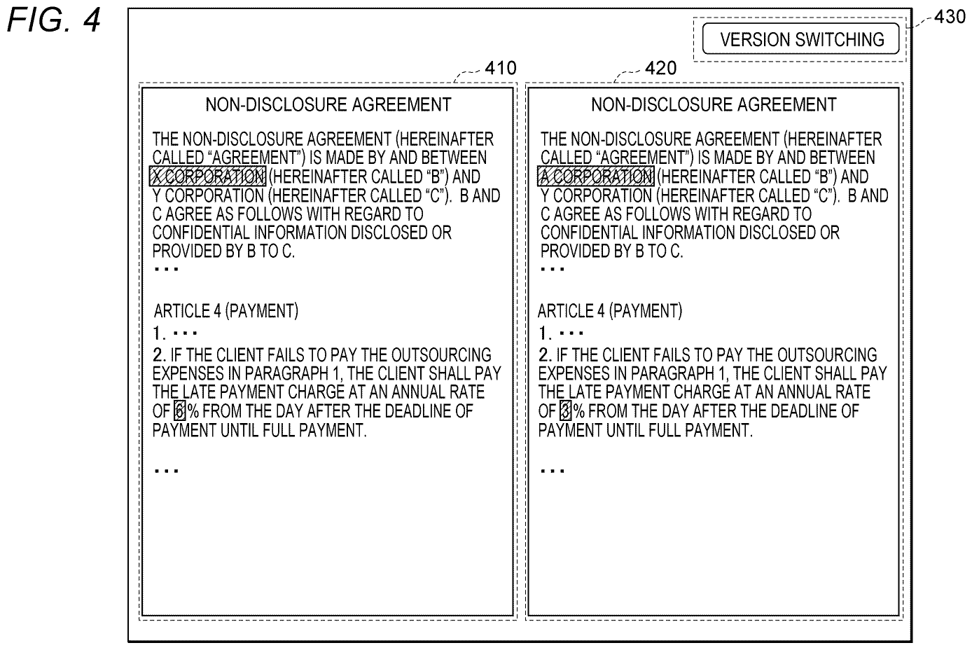

FIG. 4 illustrates an example of pre-switching display information displayed on the user terminal 200.

A screen illustrated in FIG. 4 may include, for example, a region 410 for displaying the target document information, a region 420 for displaying the first similar document information, and a region 430 that displays a selection button for a switch between versions of the first similar document information. Note that, in the present embodiment, the button displayed on the screen is an example of a user interface and thus may be, for example, an icon.

On the screen illustrated in FIG. 4, “X Corporation”, “A Corporation”, “6”, and “3” are displayed in a highlighting manner as the pre-switching difference between the region 410 and the region 420.

The screen illustrated in FIG. 4 can be regarded as a comparison preview screen on which the target document information and the first similar document information are displayed. That is, with reference to the comparison preview screen illustrated in FIG. 4, the user may check whether the extracted first similar document information is proper electronic document information for comparison to the target document information. When determining that the extracted first similar document information is proper electronic document information, the user may select the region 430. Due to processing to be described later, a switch may be made between versions of the first similar document information for comparison to the target document information.

In response to selection of the region 430, a screen corresponding to candidate display information to be described later may be displayed. Thus, from the screen illustrated in FIG. 4, the user can perform a switch operation seamlessly between versions of the first similar document information.

On the screen illustrated in FIG. 4, a plurality of pieces of first similar document information may be displayed. In this case, for example, regions 420 corresponding one-to-one to the plurality of pieces of first similar document information may be displayed on the screen illustrated in FIG. 4. Thus, with reference to each of the plurality of pieces of first similar document information, the user can select a piece of first similar document information to be referred to for comparison to the target document information and for reviewing the target document information.

On the screen illustrated in FIG. 4, the target document information and the first similar document information may be displayed in units of electronic document information or may be displayed based on a predetermined unit (e.g., article, paragraph, or item) included in the electronic document information. Thus, the user can select a predetermined unit of first similar document information to be referred to for comparison to the target document information and for reviewing the target document information.

The candidate display generation unit 135 in the present embodiment may generate candidate display information for displaying information regarding a plurality of pieces of candidate document information belonging to a series of amendment steps identical to that of the first similar document information and then store the candidate display information into the storage unit 110.

There may be a case where the first similar document information has already been amended due to user's reviewing. In the process of the amendment, the first similar document information may be amended, for example, as second-draft first similar document information, third-draft first similar document information, and final-draft first similar document information. In this case, the first-draft first similar document information, the second-draft first similar document information, the third-draft first similar document information, and the final-draft first similar document information may correspond to electronic document information belonging to a series of amendment steps. In this case, the plurality of pieces of candidate document information in the present embodiment may include, for example, the first-draft first similar document information, the second-draft first similar document information, the third-draft first similar document information, and the final-draft first similar document information.

The information regarding the plurality of pieces of candidate document information in the present embodiment may be, for example, the respective pieces of title information, respective pieces of status information, respective pieces of information indicating a creator, respective pieces of information indicating creation date or creation time, or respective pieces of information indicating update date or update time on the plurality of pieces of candidate document information, or any combination thereof.

For example, the candidate display generation unit 135 may first extract a plurality of pieces of candidate document information belonging to a series of amendment steps identical to that of the first similar document information from the electronic document information stored in a predetermined storage unit (particularly, for example, in the storage unit 110 or a storage unit in an external information processing system). Then, the candidate display generation unit 135 may generate candidate display information for displaying information regarding the plurality of pieces of candidate document information.

The candidate display generation unit 135 can generate candidate display information for displaying information corresponding to the first similar document information in a highlighting manner. Thus, the user can grasp which electronic document information is displayed on a screen corresponding to the pre-switching display information.

The candidate display generation unit 135 can generate candidate display information for displaying the information regarding the plurality of pieces of candidate document information in association with order information indicating the respective orders of amendment of the plurality of pieces of candidate document information. More specifically, for example, the candidate display generation unit 135 can generate candidate display information for displaying the plurality of pieces of candidate document information arranged in the order indicated by the order information.

The candidate display output unit 140 in the present embodiment may output candidate display information. The candidate display output unit 140 can output the candidate display information, for example, to the user terminal 200.

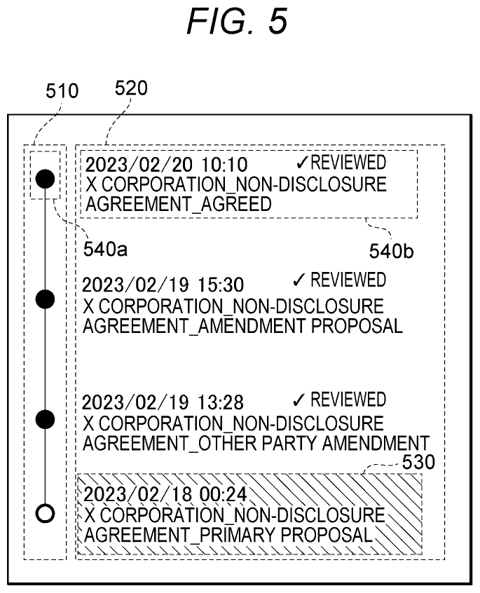

FIG. 5 illustrates an example of candidate display information displayed on the user terminal 200.

A screen illustrated in FIG. 5 may include, for example, a region 510 indicating the order of amendment, a region 520 that displays information regarding a plurality of pieces of candidate document information, and a region 530 that displays information corresponding to the first similar document information in a highlighting manner.

The region 510 can indicate the order of amendment of the plurality of pieces of candidate document information, for example, using proper figures. Thus, the user can visually grasp the order of amendment of the plurality of pieces of candidate document information. Note that, furthermore, the region 510 may display the order of amendment of the plurality of pieces of candidate document information in association with the respective pieces of status information on the plurality of pieces of candidate document information. Thus, the user can grasp the respective statuses of the plurality of pieces of candidate document information.

The region 520 may display, as the information regarding the plurality of pieces of candidate document information, for example, the respective titles, respective creation times or update times, and respective pieces of status information regarding the plurality of pieces of candidate document information. The region 520 may display information indicating the respective creation subjects on the plurality of pieces of candidate document information (our own company or the other party), namely, information indicating whether the candidate document information is document information on our own company's proposal or document information on the other party's proposal, for example.

On the screen illustrated in FIG. 5, information regarding candidate document information newer in version is displayed in an upper portion of the screen, but such information regarding candidate document information newer in version may be displayed in a lower portion of the screen. The information regarding the plurality of pieces of candidate document information may be displayed in a version order, in an update date and time order, or in a type-based or position-based division manner. More detailed information on each candidate document, such as other information not displayed on the screen of FIG. 5 or the body text of the contract, may be previewed, for example, in a pop-up manner.

The user who refers to the screen illustrated in FIG. 5 may select, from the plurality of pieces of candidate document information, electronic document information to be extracted as second similar document information to be described later. In this case, for example, the user may select the region 510 or the region 520. Specifically, for example, for selection of the electronic document information “X Corporation_non-disclosure agreement_agreed”, the user may select a region 540a or a region 540b. Then, the second comparison document extraction unit 145, which will be described later, may extract the selected electronic document information “X Corporation_non-disclosure agreement_agreed” as the second similar document information.

The screen illustrated in FIG. 5 may be displayed in superposition on the screen illustrated in FIG. 4. In this case, the screen illustrated in FIG. 5 may be displayed as a window different from that of the screen illustrated in FIG. 4 or may be displayed as the same window as the screen illustrated in FIG. 4. For display of the screen illustrated in FIG. 5 as the same window as the screen illustrated in FIG. 4, for example, due to predetermined animation, the screen illustrated in FIG. 5 may appear for display, for example, from the right end of the screen illustrated in FIG. 4. Due to such displays, through the screen illustrated in FIG. 4, the user can perform a switch operation seamlessly between versions of the first similar document information.

The second comparison document extraction unit 145 in the present embodiment may extract, based on the first comparison document information, at least one piece of second comparison document information from a plurality of pieces of document information stored in a predetermined storage unit (particularly, for example, in the storage unit 110 or a storage unit in an external information processing system) and then store the second comparison document information into the storage unit 110. The second comparison document extraction unit 145 may extract, based on the first comparison document information, at least one piece of second comparison document information belonging to an amendment process identical to that of the first comparison document information, from a plurality of pieces of document information stored in a predetermined storage unit.

In a case where the first comparison document acquisition unit 120 may acquire first similar document information as the first comparison document information, the second comparison document extraction unit 145 can extract second similar document information as the second comparison document information.

The second comparison document extraction unit 145 can extract at least one piece of second similar document information from a plurality of pieces of candidate document information, based on a selection operation from the user who refers to the display based on the candidate display information.

Specifically, the user may refer to the display based on the candidate display information through the user terminal 200. The user may operate the user terminal 200 to select information regarding candidate document information to be displayed. The second comparison document extraction unit 145 may extract, as the second similar document information, candidate document information corresponding to the selected information regarding candidate document information.

The second comparison document extraction unit 145 may extract, as the second similar document information, electronic document information identical to the first similar document information. That is, with reference to the display based on the candidate display information, the user may select the first similar document information again.

The second comparison document extraction unit 145 may extract, as the second similar document information, the latest electronic document information belonging to a series of amendment steps identical to that of the first similar document information. Thus, with reference to the content of the latest electronic document information, the user can review the target document information.

The post-switching display generation unit 150 in the present embodiment may generate post-switching display information for displaying the content of the target document information and the content of at least one piece of second similar document information and then stores the post-switching display information into the storage unit 110.

The post-switching display information in the present embodiment may be, for example, display information for displaying the content of the target document information and the content of at least one piece of second similar document information side by side.

The post-switching display generation unit 150 can generate post-switching display information for displaying, in a highlighting manner, post-switching difference indicating the difference between the target document information and at least one piece of second similar document information.

The post-switching difference in the present embodiment may be, for example, the difference between the text included in the target document information and the text included in the second similar document information or the difference between the table included in the target document information (particularly, for example, the structure of the table and the text included in the table) and the table included in the second similar document information (particularly, for example, the structure of the table and the text included in the table).

The post-switching display output unit 155 in the present embodiment may output post-switching display information. The post-switching display output unit 155 can output the post-switching display information, for example, to the user terminal 200.

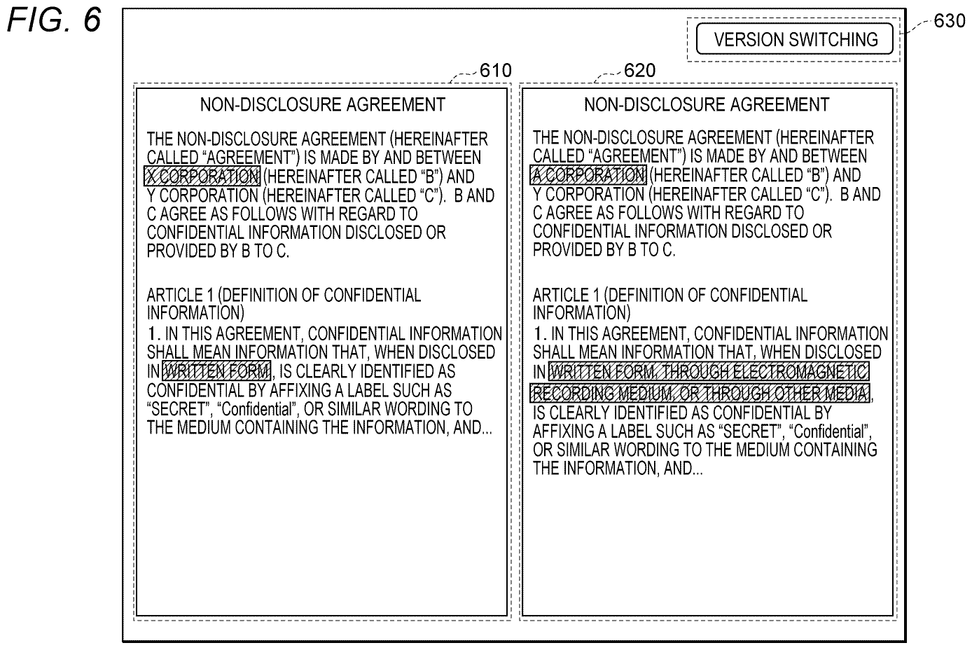

FIG. 6 illustrates an example of post-switching display information displayed on the user terminal 200.

A screen illustrated in FIG. 6 may include, for example, a region 610 for displaying the target document information, a region 620 for displaying the second similar document information, and a region 630 that displays a selection button for a switch between versions of the second similar document information.

On the screen illustrated in FIG. 6, as the pre-switching difference between the region 610 and the region 620, “X Corporation”, “A Corporation”, “in written form”, and “in written form, through electromagnetic recording medium, or through other media” may be displayed in a highlighting manner.

On the screen illustrated in FIG. 6, the target document information and the second similar document information may be displayed. With reference to the screen illustrated in FIG. 6, the user can grasp the content of a proper version of second similar document information (e.g., a latest version of electronic document information or electronic document information to which reviewing has been completed in our own company) to review the target document information.

The region 610 may display the content of the target document information in a user-editable format. Thus, with reference to the second similar document information, the user can edit the target document information.

The screen illustrated in FIG. 6 may further include a button for performing automatic amendment on the target document information, based on the second similar document information. The automatic amendment in the present embodiment may be, for example, processing in which, based on the post-switching difference, the content of the target document information is automatically amended due to computer processing to meet the content of the second similar document information. Thus, the user can review the target document information more easily.

On the screen illustrated in FIG. 6, a plurality of pieces of second similar document information may be displayed. In this case, for example, on the screen illustrated in FIG. 6, regions 620 corresponding one-to-one to the plurality of pieces of second similar document information may be displayed. In this case, the plurality of pieces of second similar document information may correspond to electronic documents belonging to the same series of amendment steps. Thus, with reference to each of the plurality of pieces of second similar document information, the user can review the target document information.

On the screen illustrated in FIG. 6, the target document information and the second similar document information may be displayed in units of electronic document information or may be displayed based on a predetermined unit (e.g., article, paragraph, or item) included in the electronic document information. In this case, the target document information may be automatically amended, based on the predetermined unit. Thus, based on the predetermined unit, the user can compare the target document information, review the target document information, or perform automatic amendment on the target document information.

Note that the screens illustrated in FIGS. 3 to 6 are display examples and thus a display interface is not limited thereto.

The document processing system 100 may perform automatic review processing on the target document information. Here, the automatic review processing may be, for example, processing in which an information processing system (e.g., the document processing system 100) evaluates the descriptions in the target document information, using a natural language processing technology, based on the difference between the descriptions in the target document information and the descriptions in a template, reviewed electronic document, or ideal electronic document (e.g., a contract).

For example, the document processing system 100 may perform automatic review processing after processing in which the second comparison document extraction unit 145 may extract second comparison document information. In this case, the document processing system 100 may output display information in which a region displaying a result of automatic review processing is additionally provided to part of the screen illustrated in FIG. 6. Thus, with reference to the second comparison document information (e.g., reviewed electronic document information), the user can evaluate a result of automatic review processing of the target document information and review the target document information.

The document processing system 100 may perform processing of outputting the second comparison document information to an external information processing system. The processing of outputting the second comparison document information may be, for example, processing of outputting the second comparison document information to the user terminal 200 in response to a request from the user through the user terminal 200.

The document processing system 100 may perform processing of outputting at least either the pre-switching difference or the post-switching difference to an external information processing system. In this case, the document processing system 100 may output the target document information and the first comparison document information or the second comparison document information, which correspond to the pre-switching difference or the post-switching difference, together to the external information processing system. The processing of outputting at least either the pre-switching difference or the post-switching difference may be, for example, processing of outputting at least either the pre-switching difference or the post-switching difference to the user terminal 200 in response to a request from the user through the user terminal 200. Thus, the user can acquire and manage, as comparative result data, a comparative result in which the target document information and the first similar document information or the second similar document information are compared.

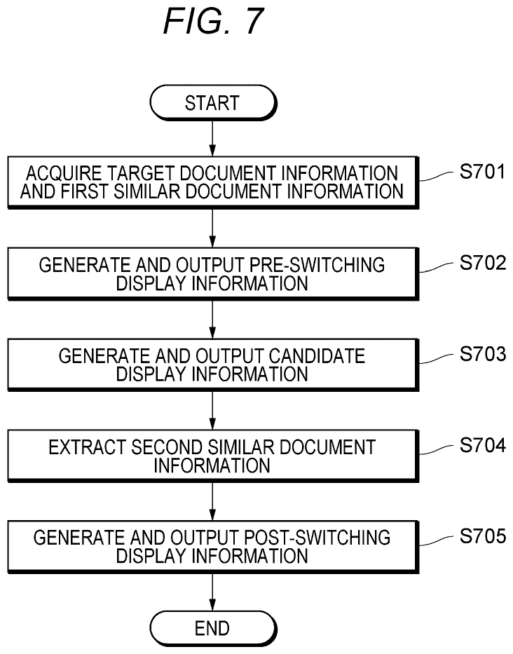

FIG. 7 is a flowchart illustrating an example of processing in the document processing system 100.

First, the target document acquisition unit 115 may acquire target document information, and the first comparison document acquisition unit 120 may acquire first similar document information (S701). The pre-switching display generation unit 125 may generate pre-switching display information, based on the target document information and the first similar document information, and the pre-switching display output unit 130 may output the pre-switching display information (S702).

The candidate display generation unit 135 may generate candidate display information, and the candidate display output unit 140 may output the candidate display information (S703). The second comparison document extraction unit 145 may extract second similar document information, based on the first similar document information (S704). In this case, the second comparison document extraction unit 145 may extract, as the second similar document information, selected candidate document information on a screen displayed based on the candidate display information.

The post-switching display generation unit 150 may generate post-switching display information, and the post-switching display output unit 155 may output the post-switching display information (S705).

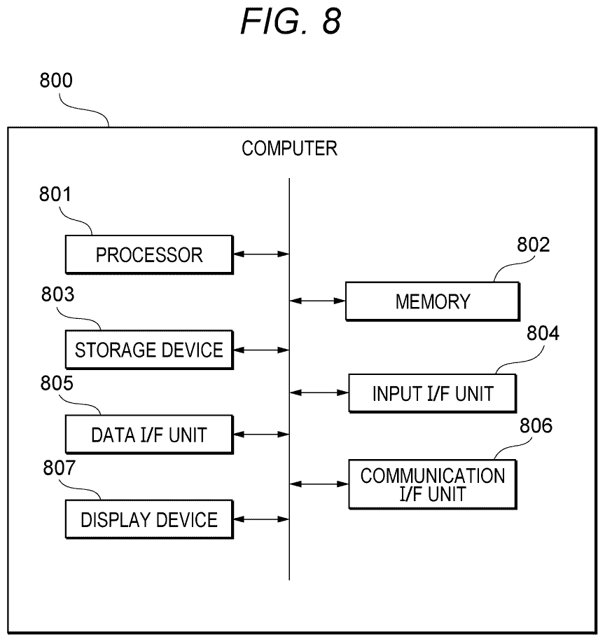

Next, an example of a hardware configuration in a case where a computer 800 may achieve the document processing system 100 will be described with reference to FIG. 8. FIG. 8 illustrates an example of a hardware configuration of the computer 800.

As illustrated in FIG. 8, the computer 800 may include, for example, a processor 801, a memory 802, a storage device 803, an input I/F unit 804, a data I/F unit 805, a communication I/F unit 806, and a display device 807.

The computer 800 may be, for example, a server computer, a personal computer (e.g., a desktop, a laptop, or a tablet), a media computer platform (e.g., a cable, a satellite set-top box, or a digital video recorder), a handheld computer device (e.g., a PDA, or an e-mail client), or another type of computer or communication platform.

The processor 801 may serve as a control unit that executes a program stored in the memory 802 to control various types of processing in the computer 800.

The memory 802 may correspond to a storage medium, such as a random access memory (RAM). The memory 802 may temporarily store a program code for a program that the processor 801 executes and data required at the time of execution of the program.

The storage device 803 may serve as a nonvolatile storage medium, such as a hard disk drive (HDD) or a flash memory. The storage device 803 may store an operating system and various types of programs for achieving the above-described configurations.

The input I/F unit 804 may serve as a device for receiving an input from a user. Examples of the input I/F unit 804 may include a keyboard, a mouse, a touch panel, various types of sensors, and a wearable device. The input I/F unit 804 may be connected to the computer 800 through an interface, such as a universal serial bus (USB) interface.

The data I/F unit 805 may serve as a device for inputting data from outside to the computer 800. Examples of the data I/F unit 805 may include a drive device for reading data stored in various types of storage media. The data I/F unit 805 may be provided outside the computer 800. In a case where the data I/F unit 805 is provided outside the computer 800, the data I/F unit 805 may be connected to the computer 800 through an interface, such as a USB interface.

The communication I/F unit 806 may serve as a device for data communication with a device outside the computer 800 in a wired or wireless manner through a network, such as the Internet. The communication I/F unit 806 may be provided outside the computer 800. In a case where the communication I/F unit 806 is provided outside the computer 800, the communication I/F unit 806 may be connected to the computer 800 through an interface, such as a USB interface.

The display device 807 may serve as a device for displaying various types of information. Examples of the display device 807 may include a liquid crystal display, an organic electro-luminescence (EL) display, and a display for a wearable device. The display device 807 may be provided outside the computer 800. In a case where the display device 807 is provided outside the computer 800, the display device 807 may be connected to the computer 800, for example, through a display cable. In addition, in a case where a touch panel is employed as the input I/F unit 804, the display device 807 may be integrated with the input I/F unit 804.

An embodiment of the present disclosure has been described above. The document processing system 100 can acquire target document information and first comparison document information and extract at least one piece of second comparison document information, based on the first comparison document information. Thus, the document processing system 100 enables the user to make a switch easily between pieces of electronic document information for comparison.

The document processing system 100 can extract at least one piece of second comparison document information belonging to a series of amendment steps identical to that of the first comparison document information. Thus, the document processing system 100 enables the user to refer to different versions of electronic document information, easily.

The document processing system 100 can output candidate display information for displaying information regarding a plurality of pieces of candidate document information and extract at least one piece of second comparison document information, based on a selection operation from the user who refers to the display based on the candidate display information. Thus, the user can easily select second comparison document information to be referred to, leading to a switch between versions.

The document processing system 100 can output candidate display information for displaying the first comparison document information in a highlighting manner. Thus, the user can make a switch between versions while grasping which one the first comparison document information is.

The document processing system 100 can output candidate display information for displaying a plurality of pieces of candidate document information in association with the respective pieces of order information thereon in a series of amendment steps. Thus, the user can make a switch between versions while grasping the amendment process of the plurality of pieces of candidate document information.

The document processing system 100 can output post-switching display information for displaying the content of the target document information and the content of at least one piece of second comparison document information. Thus, with reference to the second comparison document information, the user can review the target document information.

The document processing system 100 can output post-switching display information for displaying the post-switching difference in a highlighting manner. Thus, with reference to the difference between the content of the target document information and the content of the second comparison document information, the user can review the target document information.

The document processing system 100 can output pre-switching display information for displaying the pre-switching difference in a highlighting manner. Thus, with reference to the difference between the content of the target document information and the content of the first comparison document information, the user can make a switch between versions.

Note that the present embodiment is intended for easy understanding of the present disclosure and thus is not intended to interpret the present disclosure in a limited manner. Modifications or alterations of the present disclosure may be made without departing from the gist of the present disclosure, and equivalents thereof are included in the present disclosure.

In the present disclosure, the term “unit” does not simply mean physical means but includes a case where the function of the “unit” is achieved by software. The function of one “unit” or device may be achieved by two or more physical means, devices, or pieces of software, or the functions of two or more “units” or devices may be achieved by one physical means, device, or piece of software.

What is claimed is:

1. A document processing method to be performed by a processor, the document processing method comprising:
acquiring target document information as a target to be reviewed by a user and first comparison document information for comparison to the target document information; and
extracting at least one piece of second comparison document information from a plurality of pieces of document information stored in a predetermined storage unit, based on the first comparison document information.

2. The document processing method according to claim 1, wherein the extracting includes extracting at least one piece of second comparison document information belonging to a series of amendment steps identical to a series of amendment steps of the first comparison document information from the plurality of pieces of document information, based on the first comparison document information.

3. The document processing method according to claim 2, further comprising outputting candidate display information for displaying information regarding a plurality of pieces of candidate document information belonging to the series of amendment steps, wherein
the extracting includes extracting the at least one piece of second comparison document information from the plurality of pieces of candidate document information, based on a selection operation from the user who refers to a display based on the candidate display information.

4. The document processing method according to claim 3, wherein the plurality of pieces of candidate document information includes at least the first comparison document information, and
the candidate display information includes candidate display information for displaying, in a highlighting manner, information corresponding to the first comparison document information.

5. The document processing method according to claim 3, wherein the candidate display information includes candidate display information for displaying the information regarding the plurality of pieces of candidate document information in association with order information indicating respective orders of amendment of the plurality of pieces of candidate document information in the series of amendment steps.

6. The document processing method according to claim 2, further comprising outputting post-switching display information for displaying a content of the target document information and a content of the at least one piece of second comparison document information.

7. The document processing method according to claim 6, wherein
the post-switching display information includes post-switching display information for displaying, in a highlighting manner, post-switching difference indicating difference between the target document information and the at least one piece of second comparison document information.

8. The document processing method according to claim 2, further comprising outputting pre-switching display information for displaying the target document information and the first comparison document information with pre-switching difference indicating difference between the target document information and the first comparison document information, displayed in a highlighting manner.

9. A document processing method to be performed by a processor, the document processing method comprising:
acquiring target document information as a target to be reviewed by a user;
acquiring first similar document information similar to the target document information, based on the target document information;
outputting candidate display information for displaying a plurality of pieces of candidate document information belonging to a series of amendment steps identical to a series of amendment steps of the first similar document information;
extracting at least one piece of second similar document information from the plurality of pieces of candidate document information, based on a selection operation from the user who refers to a display of the candidate display information; and
outputting post-switching display information for displaying the at least one piece of second similar document information.

10. A document processing system comprising at least one processor, wherein
the at least one processor is configured to perform:
acquiring target document information as a target to be reviewed by a user and first comparison document information for comparison to the target document information; and
extracting at least one piece of second comparison document information from a plurality of pieces of document information stored in a storage unit, based on the first comparison document information.

11. A non-transitory computer-readable medium storing a program for causing a processor to execute:
acquiring target document information as a target to be reviewed by a user and first comparison document information for comparison to the target document information; and
extracting at least one piece of second comparison document information from a plurality of pieces of document information stored in a storage unit, based on the first comparison document information.
